(19) United States
(12) Patent Application Publication
(10) Pub. No.: US 2014/0247560 A1
(43) Pub. Date: Sep. 4, 2014

(54) SYSTEM AND METHOD TO FACILITATE THERMAL TRANSFER FOR MOTOR DRIVE FEATURES USING DIAMOND LIKE CARBON COATING

(71) Applicant: ROCKWELL AUTOMATION TECHNOLOGIES, INC., Mayfield Heights, OH (US)

(72) Inventors: Nicholas Lemberg, Milwaukee, WI (US); Garron Morris, Whitefish Bay, WI (US); Andrew Strandt, New Berlin, WI (US)

(73) Assignee: ROCKWELL AUTOMATION TECHNOLOGIES, INC., Mayfield Heights, OH (US)

(21) Appl. No.: 13/784,436

(22) Filed: Mar. 4, 2013

(51) Int. Cl. F28F 3/02; H02K 9/22

(52) U.S. Cl. CPC F28F 3/02; H02K 9/22
USPC 361/705; 165/133

(57) ABSTRACT

The present disclosure includes a motor drive that includes a rectifier module, an inverter module, drive circuitry, and a heat dissipation feature. The heat dissipation feature is at least partially coated with a diamond-like carbon material in accordance with present embodiments. The diamond-like carbon material is configured to cooperate with the heat dissipation feature placement to dissipate heat from the rectifier module, the inverter module, or the drive circuitry.

### BACKGROUND

The present disclosure relates generally to the field of motor drives. More particularly, the present disclosure relates to facilitating heat transfer through and around motor drive components using thermal interface material to improve operational efficiency of motor drives.

Motor drives include power electronic devices that cooperate to convert, produce, and apply power to loads. Depending on the desired application for a motor drive, associated motor drive circuitry may be configured to convert incoming power from one form to another as needed by the associated load. For example, a motor drive may convert power from a source into power at a different frequency in order to regulate a motor speed or the like. Specifically, for example, motor drives often include variable frequency drives that are capable of receiving constant (or varying) frequency alternating current (AC) input power from a power source (such as from a utility grid or generator) and converting the input power into controlled frequency AC output power to drive motors and other loads. These motor drives typically include rectifiers (converters), power conditioning circuits, and inverters. The rectifiers generally function to convert AC power to DC power. The power conditioning circuits (e.g., capacitors and/or inductors) generally function to remove unwanted voltage ripple on an internal DC bus of the motor drive. The inventers receive the conditioned DC power from the power conditioning circuits and convert the associated DC signal into an AC signal of a particular voltage and frequency desired for driving a motor. The inverter circuitry typically includes several high power semiconductor devices, such as insulated-gate bipolar transistors (IGBTs), silicon controlled rectifiers (SCRs), and diodes that may be coordinated using drive control circuitry.

Motor drive circuitry such as that detailed above will typically generate substantial amounts of heat, which must be dissipated to avoid damaging heat sensitive electronics. Accordingly, motor drives often employ cooling mechanisms to enhance heat extraction and dissipation. A motor drive's output is often limited by a maximum temperature that the associated circuitry can handle without substantially increasing the risk of the motor drive failing. This limit correlates to a rating for the motor drive. Accordingly, cooling mechanisms are used to assist in controlling the rating for a particular motor drive by enabling the motor drive to function a certain levels without failing due to excessive heat. It is now recognized that improved mechanisms for heat extraction and dissipation are desirable to more efficiently utilize motor drives.

### BRIEF DESCRIPTION

Present embodiments are directed to a motor drive that includes a rectifier module, an inverter module, drive circuitry, and a heat dissipation feature. The heat dissipation feature is at least partially coated with a diamond-like carbon material in accordance with present embodiments. The diamond-like carbon material is configured to cooperate with the heat dissipation feature placement to dissipate heat from the rectifier module, the inverter module, or the drive circuitry.

Present embodiments are also directed to a heat dissipation feature of a motor drive. The heat dissipation feature includes a metal plate configured to couple with an inverter module, a rectifier module, or drive circuitry of the motor drive. Further, a coating of thermal interface material including a porous diamond-like carbon material is disposed on at least a portion of the metal plate.

Present embodiments are also directed to a method of cooling a motor drive. The method includes generating heat with a power module of the motor drive. Further, the method includes transmitting the heat to a metal component to facilitate dissipation of the heat via a thermal interface material positioned adjacent the metal component, wherein the thermal interface material includes a diamond-like carbon material.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic representation of a motor drive system incorporating a component having a coating of thermal interface material in accordance with present embodiments;

FIG. 2 is a perspective view of an inverter module coupled with a heat spreader and having a coating of thermal interface material positioned therebetween in accordance with present embodiments;

FIG. 3 is a diagram of an inverter module coupled with a heat dissipation feature employing a coating of thermal interface material in accordance with present embodiments;

FIG. 4 is a schematic cross-sectional view of a portion of an inverter module coupled with a heat dissipation feature and having thermal interface material positioned therebetween in accordance with present embodiments;

FIG. 5 is a cross-sectional view generally representing the interaction between a coating of a diamond-like carbon material and a coating of thermal paste in accordance with present embodiments;

FIG. 6 is a cross-sectional view generally representing the interaction between a pair of coatings of diamond-like carbon material positioned around a coating of thermal paste in accordance with present embodiments;

FIG. 7 is plot of maximum junction temperature versus thickness of a coating of diamond-like carbon material based on simulation results in accordance with present embodiments;

FIG. 8 is a table of experimental results based on operational temperatures associated with a plain metal sheet and a metal sheet coated with a thermal interface material in accordance with present embodiments;

FIG. 9 is a schematic cross-sectional view of a heatsink coupled with a power module wherein a thermal interface material completely coats a heat spreader of the heatsink in accordance with present embodiments;

FIG. 10 is a schematic cross-sectional view of a heatsink coupled with a power module wherein a thermal interface material coats a portion of a heat spreader of the heatsink in accordance with present embodiments;

FIG. 11 is a schematic cross-sectional view of a heatsink coupled with a power module wherein a thermal interface material coats the entire heatsink in accordance with present embodiments;

FIG. 12 is a schematic cross-sectional view of a heatsink coupled with a power module wherein a thermal interface material coats a portion of a baseplate attached to the heatsink in accordance with present embodiments;

FIG. 13 is a schematic cross-sectional view of a heatsink coupled with a power module wherein a thermal interface material coats an entire baseplate attached to the heatsink in accordance with present embodiments; and

FIG. 14 is a schematic cross-sectional view of a heatsink including a coating of thermal interface material between a heat spreader and each fin of the heatsink and a coating of the thermal interface material on a side of the heat spreader opposite the fins in accordance with present embodiments.

### DETAILED DESCRIPTION

Present embodiments relate to systems and methods for efficiently extracting and dissipating heat from motor drive components or features. More specifically, present embodiments include employing one or more coatings or layers of thermal interface materials, including diamond-like carbon (DLC), on motor drive components to improve heat transfer characteristics. Indeed, the DLC, alone or in conjunction with another thermal interface material, functions to increase thermal conductivities associated with a coated motor drive component, and, thus, enhance cooling of the component relative to operation without the coating. For example, present embodiments include applying a coating of DLC material on certain motor drive components (e.g., a heatsink) via an immersion bath process to increase a thermal conductivity associated with the coated components and achieve more efficient cooling of the corresponding motor drive. As another example in accordance with present embodiments, multiple thermal interface layers are arranged and configured to cooperatively increase the heat transfer away form certain motor drive components relative to operation without the coordinated layers. For example, present embodiments include a thermal grease or thermal paste that cooperates with one or more DLC coatings to more efficiently transfer heat. In a specific embodiment, for example, a portion of a heat spreader may be coated with the DLC material and mated with a baseplate having a coating of thermal paste such that the thermal paste contacts the DLC material to provide a two-layer thermal interface.

Utilization of present embodiments with appropriate features of a motor drive will generally result in increasing the power density of the motor drive. In other words, by employing coatings in accordance with present embodiments, the thermal performance (e.g., thermal capacity) of cooling features of a motor drive will improve such that the motor drive's rating can be increased despite no other aspect of the motor drive changing. A motor drive capable of dissipating heat more efficiently can perform at levels typically requiring larger motor drives because high heat thresholds are often a limiting factor for motor drive performance. However, because of the efficiency associated with employing the thermal interface material in accordance with present embodiments, essentially no additional physical space is required to achieve higher performance. By utilizing present embodiments, a motor drive can achieve a higher rating that would typically require an increased physical footprint for the motor drive. Thus, present embodiments are spatially and economically efficient. As a specific example, utilizing thermal interface material coatings in accordance with present embodiments on features of the POWERFLEX 750 series drives (among other motor drives available from ROCKWELL AUTOMATION, Inc. headquartered at 1201 S. 2nd St. Milwaukee, Wis., 53204, US) will increase the rating of these motor drives without substantially impacting the physical footprint of the motor drives.

In addition to avoiding device failures associated with high temperature operation, present embodiments also resist deterioration of certain system components. When appropriately applied to motor drive components, the one or more coatings of thermal interface materials (including the DLC material) described above may limit certain types of wear. For example, the levels of wear that traditionally accompany utilization of motor drive components when they are not coated with thermal interface material may be reduced by applying the thermal interface material to dissipate heat in accordance with present embodiments. Specifically, for example, mechanical stresses associated with high temperatures at a junction between an IGBT and other system components can result in damage to associated contacts (e.g., wire bonding and soldering). However, present embodiments may limit such wear by efficiently dissipating the heat that causes such stresses.

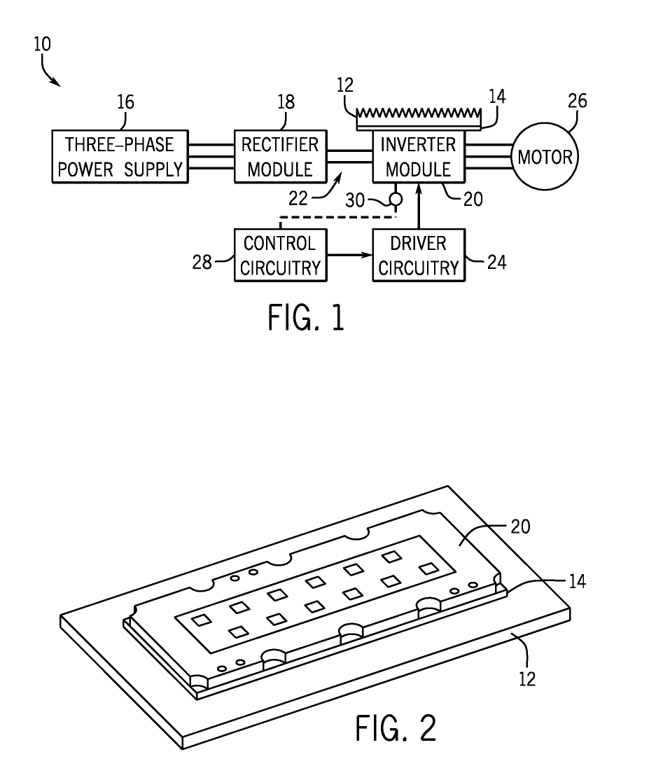

FIG. 1 is a schematic diagram of a motor drive system 10 employing a heat dissipation feature 12 (e.g., a heatsink) coated with thermal interface material 14 (e.g., DLC material and/or thermal paste) in accordance with present embodiments. Specifically, in the illustrated embodiment, a three-phase power supply 16 (e.g., a generator or power grid) provides a three-phase voltage waveform at a constant frequency to a rectifier module 18. The rectifier module 18 is configured to perform full wave rectification of the three-phase AC voltage waveform, outputting a DC voltage to an inverter module 20 via a DC bus 22. The inventor module 20 receives the DC voltage and outputs a discretized three-phase waveform at a desired frequency that is independent of what was provided by the three-phase power supply 16. Driver circuitry 24 provides the inverter module 20 with control signals to actuate aspects of the inverter module 20 to enable the inverter module 20 to generate a three-phase waveform with desired characteristics for powering a load 26 (e.g., a motor). Control circuitry 28 provides commands to the driver circuitry 24 to enable proper control of the inverter module 20 based on feedback from one or more sensors 30 (e.g., temperature sensors) of the inverter module.

It should be noted that, in the illustrated embodiment, the inverter module 20 includes or incorporates the heat dissipation feature 12, which is coated with the thermal interface material 14 to increase the power density of the system 10 relative to employing the system 10 without the thermal interface material 14. In other embodiments, different or additional features of the system may include the thermal interface material 14 to increase the power density of the system 10. For example, in some embodiments, the rectifier module 18 may utilize heat dissipation features that incorporate one or more thermal interface layers including DLC material. Indeed, combinations of thermal interface material 14 coatings may be employed with any of the various components of the motor drive system 10, such as components of the rectifier module 18, inverter module 20, driver circuitry 24, control circuitry 28, and so forth.

FIG. 2 is a perspective view of one embodiment of the inverter module 20 coupled with the heat dissipation feature 12, wherein the heat dissipation feature 12 includes a partial coating of the thermal interface material 14 in accordance with present embodiments. In particular, in the illustrated embodiment, the thermal interface material 14 is essentially positioned only under the outer boundaries of the inverter module 20. In other embodiments, different relative arrangements of the thermal interface material 14 may be employed. For example, the thermal interface material 14 may be deposited directly on a baseplate of the inverter module 20, such that it is only within the exact boundaries of the inverter module 20. In yet other embodiments, the thermal interface material 14 may completely coat or partially coat an entire heatsink, a heat spreader, and/or a baseplate. Application of a coating of the thermal interface material 14, including the DLC material, will generally discolor and change the texture of the heat dissipation material being coated. For example, an aluminum component will transition to a dark and dull tone after coating. Further, the aluminum component will have a rough texture after coating. Any of various types of material may be coated in accordance with present embodiments. In particular, copper and aluminum are examples of material that may be coated to facilitate heat transfer.

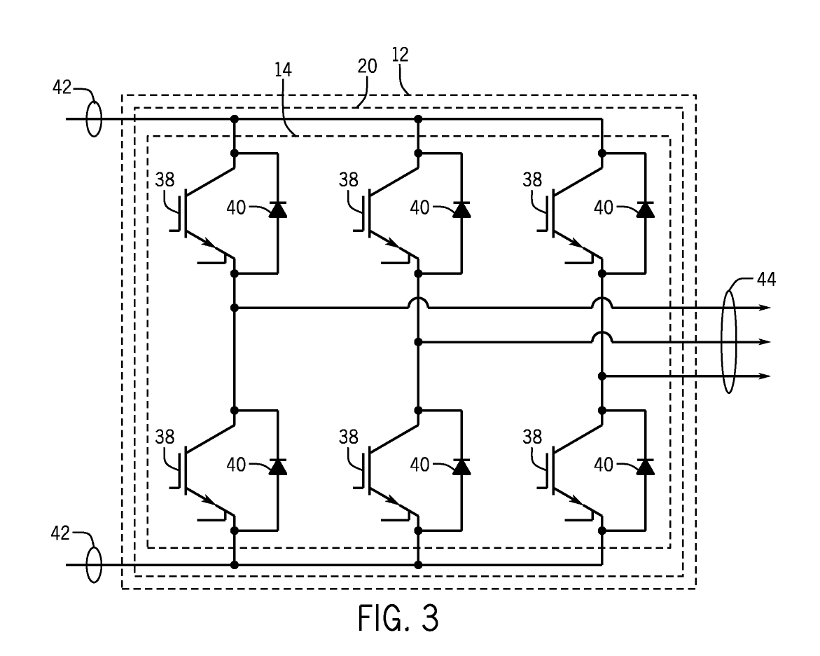

As illustrated by the schematic representation of FIG. 3, the inverter module 20 may include a plurality of IGBTs 38 and power diodes 40. The IGBTs 38 and power diodes 40 are joined to positive or negative DC lines 42 (as appropriate) and output lines 44. During operation, while the IGBTs 38 are being rapidly switched on and off to produce a discretized three-phase output current waveform via the output lines 44, a substantial amount of heat may be generated by the IGBTs 38. In particular, heat may be concentrated at junctions between the IGBTs 38 and other components of the inverter module 20. The associated temperature, which can generally be identified as the temperature of the IGBTs 38, may be referred to herein as the junction temperature. Because the junction temperature must be dissipated to accommodate higher ratings for associated motor drives and to resist wear associated with high temperatures (e.g., cracking and deformation of bonding areas), present embodiments include the heat dissipation feature 12. In the illustrated embodiment, the heat dissipation feature 12, which is a heat transfer mechanism (e.g., a heatsink), is coupled with the inverter module 20. The heat dissipation feature 12 may include a heat spreader, air-cooled heatsink, water-cooled heatsink, vapor chamber, heat pipe, or the like. Further, in order to increase the efficiency of operation of the heat dissipation feature 12, the thermal interface material 14 (including at least DLC material) is positioned between the heat dissipation feature 12 and the inverter module 20. Due to the concentrated heat generated relative to the positioning of IGBTs 38, the thermal interface material 14 may be specifically located proximate the IGBTs 38. For example, the thermal interface material 14 may only be included directly under the inverter module 20 (e.g., directly under the inverter module 20 and between a baseplate of the inverter module 20 and the heat dissipation feature 20) or only in alignment with the area covered by the IGBTs 38 within the inverter module 20. However, various coating techniques, including coating entire components, are in accordance with the present disclosure.

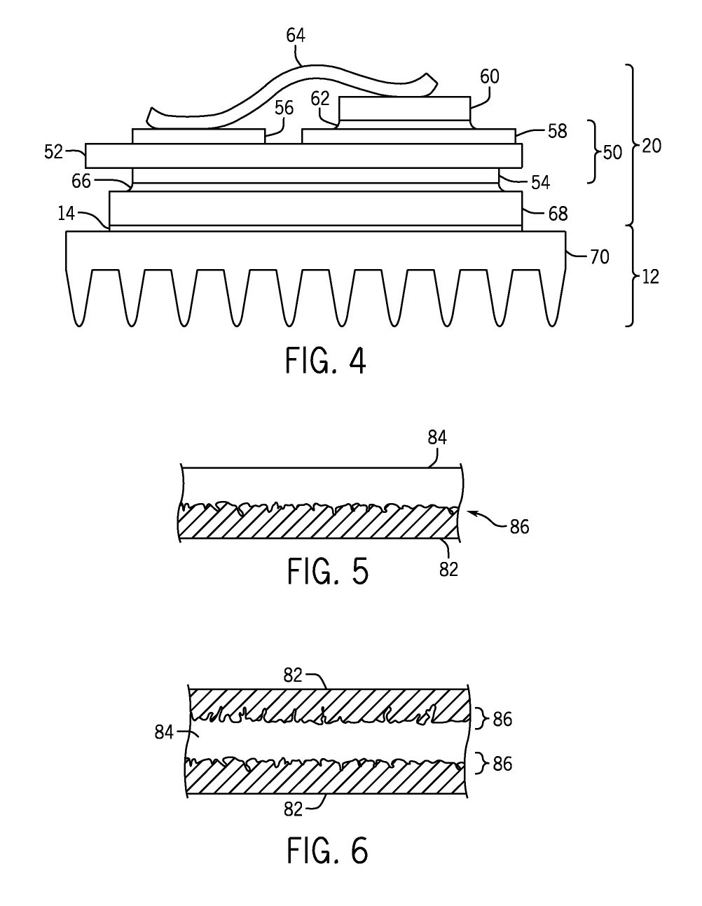

FIG. 4 is a schematic cross-sectional view of a portion of the inverter module 20 coupled with the heat dissipation feature 12 and having the thermal interface material 14 positioned there between in accordance with present embodiments. As illustrated, the inverter module 20 includes a direct bond copper (DBC) substrate 50, which includes a ceramic base 52, a copper layer 54, and copper contacts 56, 58. A die 60 (e.g., a silicon IGBT) is joined to the copper contact 58 by solder 62. Bond wire 64 joins the die 60 to the copper contact 56. As previously noted, high junction temperature may cause degradation of certain components. For example, the DBC substrate 50 may expand unevenly, creating tension on the bond wire 64 and at the solder connections that may eventually result in failure. In view of such results, it is clear that the temperature associated with operation of the die 60 may have a substantial effect on the life of the inverter module 20. Similarly, the operation temperatures have an impact on power density of the motor drive that incorporates the inverter module 20. Accordingly, present embodiments include the heat dissipation feature 12 and the thermal interface material 14 to facilitate removal of heat from proximate the die 60 and reduction of the associated junction temperature. For example, in the illustrated embodiment, the DBC substrate 50 is coupled with solder 66 to a baseplate 68, which is coupled to a heatsink 70 with the thermal interface layer 14 positioned between the baseplate 68 and a base (e.g., heat spreader) of the heatsink 70.

The thermal interface layer 14 includes at least the DLC material, which may include diamond-like carbon or diamond particulates dispersed in an autocatalytic nickel alloy matrix. The DLC material may include 29-31% or approximately 30% (e.g., 25%-35%) diamond but includes a mix of carbon that is diamond-like. With respect to heat conduction, the DLC material is believed to be approximately four times as conductive as copper. The DLC material is applied to a motor drive component via an immersion process similar to electroplating, which is believed to result in a thicker and more porous layer of the DLC material relative to other traditional application processes (e.g., chemical vapor deposition) for other types of layers. In accordance with present embodiments, the DLC layer may not be a solid layer. Rather, an applied DLC layer may be porours. The DLC material has been designed to improve wear resistance of gears and similar mechanical components designed for applications involving constant contact between metallic surfaces. The DLC material may be acquired from ENDURA Coatings headquartered at 42250 Yearego Drive, Sterling Heights, Mich. 48314, US. Specifically, the DLC material may include material identified as Series 1100 CDC Coating available from ENDURA Coatings.

The thermal interface layer 14 may also include other components. Indeed, in accordance with present embodiments, the thermal interface layer 14 illustrated in FIG. 4 may represent at least a two-part thermal interface material or a bilayer. Specifically, the thermal interface layer 14 may include a coating of the DLC material and a coating of thermal paste. Thermal paste (which may also be referred to as thermal grease, thermal gel, thermal compound, heat paste, heat sink paste or heat sink compound) includes a viscous fluid that allow it to fill gaps between interfacing elements to facilitate heat transfer relative to having the gaps filled with air. The thermal paste may include metal particles suspended in silicone or non-silicone based oil. In present embodiments, the DLC material has a level of porosity that is understood to cooperate with the viscosity of the thermal paste to create an intermingling of the DLC material and the thermal paste. For example, FIG. 5 illustrates a cross-sectional view of what is believed generally represents the interaction between a coating of DLC material 82 and a coating of thermal paste 84, wherein the thermal paste 84 has essentially leached into a porous area 86 of the DLC material 82. FIG. 5 may be representative of interaction between a single component (e.g., a heat spreader) coated with the DLC material 82 and the thermal paste 84. In other embodiments, multiple components may be coated with the DLC material 82. For example, a heat spreader and a baseplate of a inverter module may both be coated with the DLC material 82 and coupled together about a layer of the thermal paste 84, which would result in intermingling of the thermal paste 84 with both layers of the DLC material 82, as generally illustrated in FIG. 6, which illustrates the thermal paste 84 leaching into two porous areas 86 corresponding to two layers of the DLC material 82.

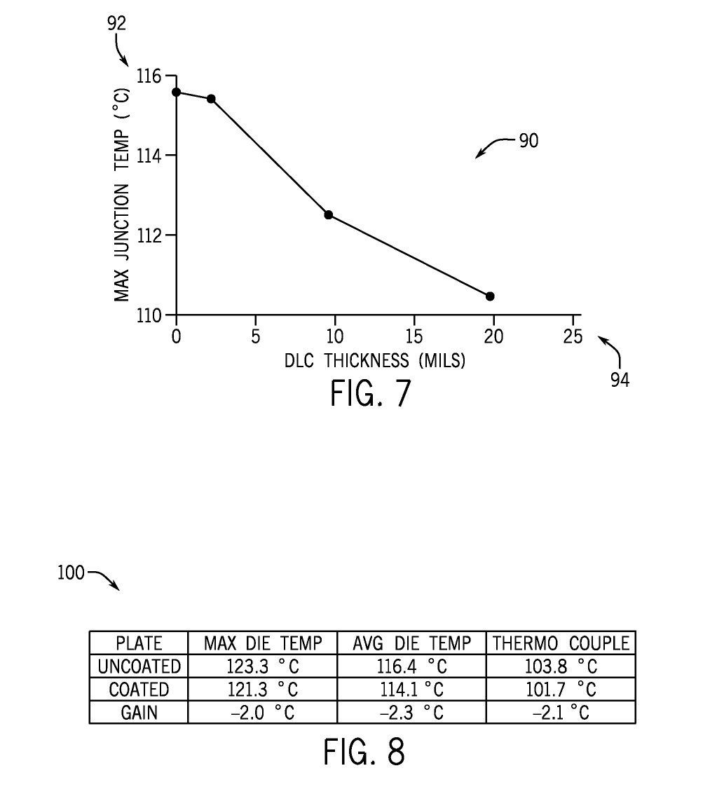

The intermingling or overlapping of at least one layer of the DLC material 82 and a layer of the thermal paste 84 is believed to result in unexpectedly improved heat transfer properties for motor drive components coated with such layers. Initial simulations of various coating thicknesses applied to a heatsink base resulted in maximum junction temperatures that progressively decreased with added thickness levels of the simulated DLC material 82 to the heatsink base. Indeed, as illustrated by the chart 90 in FIG. 7, substantial reductions in the simulated maximum junction temperature were achieved with progressively thicker coatings of the DLC material 82. The chart 90 plots a maximum junction temperature associated with simulated IGBTs of a motor drive on a Y-axis 92 relative to a thickness of DLC material applied to an associated heatsink on an X-axis 94. Specifically, the chart 90 shows that a baseline simulation for an inverter with a bare heatsink (without ay DLC material) resulted in a maximum junction temperature (MJT) of 115.4° C.; a simulation with a 2 mil coating of the DLC material on the heatsink resulted in a MJT of 115.3° C.; a simulation with a 10 mil coating of the DLC material on the heatsink resulted in a MJT of 112.8° C.; and a simulation with a 20 mil coating of the DLC material on the heatsink resulted in a MJT of 110.8° C.

Table 100 in FIG. 8 includes data from actual testing that demonstrates that the use of DLC material as a coating for a heat dissipation feature can substantially reduce operational temperatures of a motor drive. The results set forth in the table 100 were identified via experimentation with a DLC coating on an aluminum plate and operation with a IGBT module. Two aluminum baseplates (heat spreaders) were machined and one of the aluminum baseplates was coated with a thickness of approximately 2.0 mils of DLC material. The same IGBT module was mounted on each of the baseplates to acquire test data. DC current at the same rate was passed through the diodes of the IGBT module while mounted to each baseplate. An IR camera was used to measure a steady-state die temperature for each scenario. Also, internal thermocouples (negative temperature coefficient or NTC thermocouples integral with IGBT chips) for the IGBT module provided temperature measurements. The results for each baseplate are set forth in the table 100. For the bare aluminum baseplate, a maximum die temperature of 123.3° C., average die temperature of 116.4° C., and a thermocouple temperature of 103.8° C. were detected. For the coated aluminum baseplate a maximum die temperature of 121.3° C., average die temperature of 114.1° C., and a thermocouple temperature of 101.7° C. were detected. This demonstrates that the low cost option of adding a coating of the DLC material to even a heat spreader alone can reduce both die and thermocouple temperatures by 2° C. to 2.3° C. Based on such reductions in temperature, a rating of an associated motor drive could be increased.

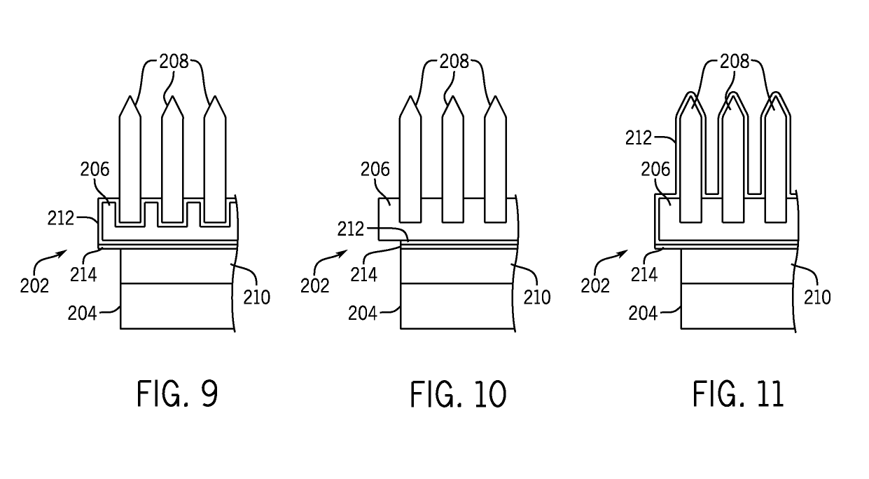

As will be discussed below, present embodiments include specific placements of thermal interface material layers or coatings to address specific functionality issues associated with coated components and for purposes of efficiency in application of the thermal interface material. In accordance with present embodiments, components are coated to facilitate heat dissipation away from modules that incorporate a plurality of power electronic dies (e.g., IGBTs). FIGS. 9-13 represent schematic cross-sectional views of a heatsink 202 coupled with a power module 204 (e.g., rectifier or inverter) of a motor drive to illustrate examples of coating schemes in accordance with present embodiments. Each of FIGS. 9-13 includes the heatsink 202, which includes a heat spreader 206 and fins 208. In some embodiments, these features may be integral. The heatsink 202, which is representative and could be replaced with other types of heat dissipation features, is coupled with the power module 204 in each of FIGS. 9-13 via a baseplate 210. Further each of FIGS. 9-13 includes at least one layer of DLC material 212 and at least one layer of thermal paste 214. While not illustrated, as discussed above, the thermal paste 214 may essentially leach into porous regions of the layer of DLC material 212 to create some overlap.

Specifically, FIG. 9 illustrates the layer of DLC material 212 completely coating outer portions of the heat spreader 206 and coupled with the baseplate 210 with the thermal paste 214 there between. This complete coating of the heat spreader 206 may improve heat transfer characteristics of the heat spreader 206 and simplify application of the layer of DLC material 212. However, in other embodiments, efforts may be made to position the layer of DLC material 212 on a limited portion of certain components, such as the heat spreader 206. For example, FIG. 10 illustrates only a portion of the heat spreader 206 being coated with the layer of DLC material 212 and being placed adjacent the baseplate 210 having an entire side coated with the thermal paste 214. This positioning of the layer of DLC material 212 in such an embodiment may correspond to the size of the baseplate 210, positioning of the fins 208, positioning of die (e.g., IGBTs) in the power module 204, and so forth. Further, limited application may conserve expenses associated with the layer of DLC material 212 and/or thermal paste 214. As another example, the entire heatsink 202 may be coated with the layer of DLC material, as illustrated in FIG. 11. It should be noted that present embodiments include these components provided separately and/or arranged in a system.

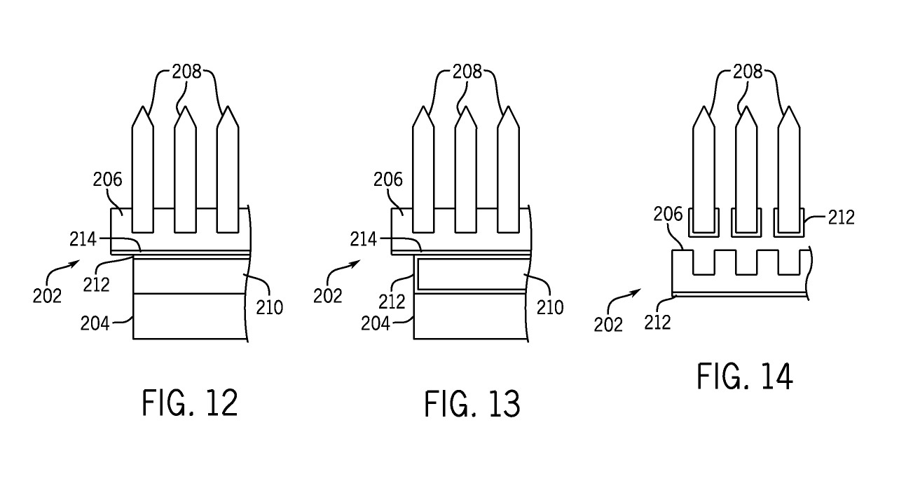

FIGS. 9, 10, and 11 generally illustrate providing the layer of DLC material 212 on features of the heatsink 202. However, in other embodiments, different or additional motor drive components may be coated. For example, as illustrated in FIGS. 12 and 13, the baseplate 210 may be coated with the layer of DLC material 212. FIG. 12 illustrates a partial coating of the baseplate 210 and FIG. 13 illustrates a complete coating of the baseplate 210. In both embodiments, a full side of the heatsink 202 is coated with the layer of thermal paste 214 such that it engages with the layer of DLC material 212 on the baseplate 210. In other embodiments, both the heatsink 202 and the baseplate 201 may include layers of the DLC material 212. Further, in some embodiments, the heatsink 202 may include thermal interface materials to facilitate heat transfer within the heatsink 202. For example, in FIG. 14, the heatsink 202 includes layers of the DLC material 212 on each fin 208 to facilitate heat transfer between the fins 208 and the heat spreader 206 while also including a separate layer of DLC material 212 on the heat spreader 206 arranged for coupling with the baseplate 210 or the like and the facilitate heat transfer therethrough. It should be noted that present embodiments may include any combination of the layer arrangements illustrated in FIGS. 9-14. Furthermore, the power module 204 may represent various different modules or components of the system 10.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A motor drive, comprising:
a rectifier module;
an inverter module;
drive circuitry; and
a heat dissipation feature at least partially coated with a diamond-like carbon material configured to dissipate heat from the rectifier module, the inverter module, or the drive circuitry.

2. The motor drive of claim 1, comprising a coating of thermal paste interfacing with the diamond-like carbon material such that the thermal paste infiltrates pores of the diamond-like carbon material.

3. The motor drive of claim 1, wherein the heat dissipation feature comprises a heatsink, a heat spreader, or a baseplate.

4. The motor drive of claim 1, wherein the heat dissipation feature is coupled with the inverter module and configured to dissipate heat generated by a plurality of IGBT dies of the inverter module.

5. The motor drive of claim 4, wherein the diamond-like carbon material is aligned with and disposed only within the boundaries of a perimeter of the inverter module.

6. The motor drive of claim 1, wherein the diamond-like carbon material forms a layer having a thickness of approximately 2-20 mils.

7. The motor drive of claim 1, wherein the diamond-like carbon material is positioned and configured to reduce a maximum die temperature of the inverter module by at least 2° C. relative to the heat dissipation feature operating without the diamond-like carbon material.

8. The motor drive of claim 1, wherein the diamond-like carbon material comprises approximately 30% diamond.

9. The motor drive of claim 1, wherein the heat dissipation feature comprises a heatsink and a baseplate, wherein one or both of the heatsink and the baseplate is at least partially coated with the diamond-like carbon material

10. A heat dissipation feature of a motor drive, comprising:
a metal plate configured to couple with an inverter module, a rectifier module, or drive circuitry of the motor drive; and
a coating of thermal interface material including a porous diamond-like carbon material disposed on at least a portion of the metal plate.

11. The heat dissipation feature of claim 10, wherein the thermal interface material includes the diamond-like carbon material disposed adjacent a thermal paste that infiltrates pores of the diamond-like carbon material.

12. The heat dissipation feature of claim 11, wherein the thermal paste comprises metal particle suspended in silicone or non-silicone oil.

13. The heat dissipation feature of claim 10, wherein the metal plate comprises a heat spreader configured to couple with heatsink fins or a baseplate configured to couple with the inverter module.

14. The heat dissipation feature of claim 10, wherein the metal plate is a component of a heatsink that is fully coated by the diamond-like carbon material and configured to couple with a baseplate of the inverter module.

15. The heat dissipation feature of claim 10, wherein the metal plate is configured to couple with the inverter module and the diamond-like carbon material is positioned to at least align with IGBT dies within the inverter module to facilitate dissipating heat generated by the IGBT dies during operation of the inverter module.

16. The heat dissipation feature of claim 10, wherein the metal plate comprises aluminum or copper.

17. A method of cooling a motor drive, comprising:
generating heat with a power module of the motor drive;
transmitting the heat to a metal component to facilitate dissipation of the heat via a thermal interface material positioned adjacent the metal component, wherein the thermal interface material includes a diamond-like carbon material.

18. The method of claim 17, wherein the thermal interface material includes a thermal paste interfacing with pores of the diamond-like carbon material.

19. The method of claim 17, comprising reducing a temperature of the power module by at least 2° C. relative to operation without the thermal interface material.

20. The method of claim 17, comprising transmitting heat from the metal component to an additional metal component via additional thermal interface material positioned between the metal component and the additional metal component.
